(19) United States
(12) Patent Application Publication
(10) Pub. No.: US 2025/0117947 A1
(43) Pub. Date: Apr. 10, 2025

(54) EFFICIENT TRANSFORMER-BASED PANOPTIC SEGMENTATION

(71) Applicant: NEC Laboratories America, Inc., Princeton, NJ (US)

(72) Inventors: Abhishek Aich, San Jose (IS); Yumin Suh, Santa Clara, CA (US); Samuel Schulter, Long Island City, NY (US); Manyi Yao, Princeton, NJ (US)

(21) Appl. No.: 18/893,037

(22) Filed: Sep. 23, 2024

Related U.S. Application Data
(60) Provisional application No. 63/542,368, filed on Oct. 4, 2023.
(60) Provisional application No. 63/558,861, filed on Feb. 28, 2024.
(60) Provisional application No. 63/561,880, filed on Mar. 6, 2024.

(51) Int. Cl. G06T 7/11; B60W 30/09; G06V 10/40; G06V 10/764

(52) U.S. Cl. CPC G06T 7/11; B60W 30/09; G06V 10/40; G06V 10/764

(57) ABSTRACT

Methods and systems for segmentation include encoding an image using a backbone model to generate feature maps. An exit point based on one of the feature maps. The feature maps are processed with a dynamic transformer encoder that includes layers, exiting the dynamic transformer encoder at a layer identified by the exit point. An output of the dynamic transformer encoder is decoded to output a segmentation of the image.

### RELATED APPLICATION INFORMATION

This application claims priority to U.S. Patent Application No. 63/542,368, filed on Oct. 4, 2023, to U.S. Patent Application No. 63/558,861, filed on Feb. 28, 2024, and to U.S. Patent Application No. 63/561,880, filed on Mar. 6, 2024, each incorporated herein by reference in its entirety.

### BACKGROUND

### Technical Field

The present invention relates to computer vision systems and, more particularly, to transformer-based panoptic segmentation.

### Description of the Related Art

Panoptic segmentation is a computer vision task that segments different object categories and predicts associated labels. However, panoptic segmentation can be computationally intensive, particularly in embedded applications where real-time reactions to changing conditions are important. This problem is exacerbated when large images are processed.

### SUMMARY

A method for segmentation includes encoding an image using a backbone model to generate feature maps. An exit point based on one of the feature maps. The feature maps are processed with a dynamic transformer encoder that includes layers, exiting the dynamic transformer encoder at a layer identified by the exit point. An output of the dynamic transformer encoder is decoded to output a segmentation of the image.

A system for segmentation includes a hardware processor and a memory that stores a computer program. When executed by the hardware processor, the computer program causes the hardware processor to encode an image using a backbone model to generate a plurality of feature maps, to select an exit point based on one of the plurality of feature maps, to process the feature maps with a dynamic transformer encoder that includes a plurality of layers, exiting the dynamic transformer encoder at a layer identified by the exit point, and to decode an output of the dynamic transformer encoder to output a segmentation of the image.

An autonomous vehicle includes a camera that captures an image of a scene, a hardware processor, and a memory that stores a computer program. When executed by the hardware processor, the computer program causes the hardware processor to encode an image using a backbone model to generate a plurality of feature maps, to select an exit point based on one of the plurality of feature maps, to process the feature maps with a dynamic transformer encoder that includes a plurality of layers, exiting the dynamic transformer encoder at a layer identified by the exit point, to decode an output of the dynamic transformer encoder to output a segmentation of the image, and to perform a steering, accelerating, or decelerating action responsive to the segmentation to avoid an obstacle or hazard in the scene shown by the image.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing an exemplary road scene captured by an autonomous vehicle for segmentation, in accordance with an embodiment of the invention;

FIG. 2 is a block/flow diagram of a method for performing segmentation of an image including dynamic selection of an exit point for a transformer encoder, in accordance with an embodiment of the present invention;

FIG. 3 is a block/flow diagram of a method for training a dynamic segmentation model, in accordance with an embodiment of the present invention;

FIG. 4 is a diagram illustrating automated control systems for an autonomous vehicle, in accordance with an embodiment of the present invention;

FIG. 5 is a block diagram of a computing device that can perform dynamic segmentation, in accordance with an embodiment of the present invention;

FIG. 6 is an exemplary neural network architecture that can be used to implement part of a dynamic segmentation model, in accordance with an embodiment of the present invention; and

FIG. 7 is an exemplary deep neural network architecture that can be used to implement part of a dynamic segmentation model, in accordance with an embodiment of the present invention.

### DETAILED DESCRIPTION OF PREFERRED EMBODIMENTS

Vision transformers may be used for panoptic segmentation. A dynamic transformer encoder may be used, where the model can choose to discard hidden layers based on the complexity of an input image. The number of hidden layers being used may be controlled by a gating function implemented by a simple linear layer. Unneeded computations can be skipped in the model based on the complexity of the input image, resulting in a further reduction of the computational cost without jeopardizing performance.

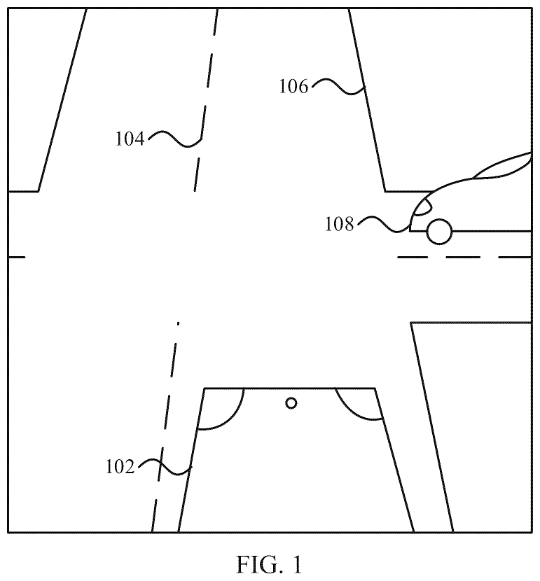

Referring now to FIG. 1, an example scene is shown. The scene may be captured by a camera that is mounted on a vehicle 102, and may show the surroundings of the vehicle 102 from a particular perspective. It should be understood that multiple such images may be used to show various perspectives, to ensure awareness of the vehicle's entire surroundings. In some cases, a panoramic or 360° camera may be used.

Panoptic segmentation may process an image of the scene and identify different objects that are shown in the scene. For example, the segmentation may detect environmental features, such as the road boundary 106 and lane markings 104, as well as moving objects, such as other vehicles 108. Using this information, a navigation or self-driving system in the vehicle 102 can safely navigate through the scene.

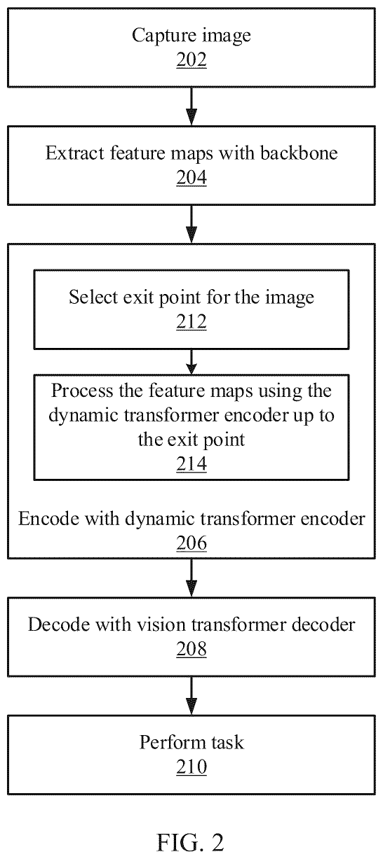

Referring now to FIG. 2, a method for panoptic segmentation is shown. Block 202 captures an image of a scene using, for example, a camera or video camera. A backbone model may include a hierarchical visual transformer encoder that is preloaded with pre-trained weights. The backbone generates multi-scale feature maps that can cater to both small-scale and large-scale object segmentation.

Block 206 uses a dynamic transformer encoder to create per-pixel embeddings, for example using a stack of deformable attention transformer layers that can be skipped in accordance with a gating function as discussed in greater detail below. The gating function may include a linear layer that causes the transformer layer to exit based on the multi-scale feature maps.

Block 208 then decodes using a vision transformer decoder, which may include multiple vision transformer layers that operate on per-pixel embeddings to process object queries. The vision transformer decoder outputs a binary prediction mask, which may be decoded from per-pixel embeddings with the object queries. Based on the prediction, some downstream task is performed 210, for example in the autonomous operation of a vehicle 102.

Following the example of operating an autonomous vehicle in performing the task 210, the output of the vision transformer decoder may include a breakdown of the objects within the scene and their significance. Thus, a given object may be identified as a stationary obstacle, another vehicle, a pedestrian, a road hazard, or any other object of interest. The task may therefor use the information to perform a steering or speed change operation. For example, the vehicle 102 may be steered to avoid an obstacle or to follow road markings. The vehicle 102 may be accelerated or decelerated to provide safe transit on the road. The panoptic segmentation of the image may thereby provide safe operation of the vehicle.

In another example, panoptic segmentation may be used to identify structures and cell types within an image of a tissue sample. This may be used to, for example, identify cancerous tissue in a tissue sample. The task may then include performing a treatment responsive to the detection of cancer, for example by automatically administering chemotherapy or by conducting a surgery to remove the cancerous tissue.

As part of the encoding 206, block 212 uses the gating network to select the exit point for the captured image. This exit point may be selected based on a lowest-resolution feature map from the backbone, and so may differ from one image to the next. Block 214 then processes the feature maps using the dynamic transformer encoder, but only uses transformer layers up to the exit point. Any transformer layers after the exit point are not executed for this image.

The backbone may be expressed as a function b(·) which takes the i^{th} image in a sequence x⁽ⁱ⁾ as input to generate multi-scale feature maps b(x⁽ⁱ⁾), represented as s₁, s₂, s₃, s₄. These multi-scale feature maps correspond to spatial resolutions, such as 1/32, 1/16, ⅛, and ¼ of the original image size, respectively. The transformer encoder may include multiple layers of transformer encoders. The function of the transformer encoder is to generate rich token representation from {s₁, s₂, s₃} and generate per-pixel embeddings from s₄. Each layer in the transformer encoder, denoted as fₖ(·) (where k∈{1,2, . . . , K}) is successively applied to b(x⁽ⁱ⁾), with fₖ(·) being the last layer in the transformer encoder. The transformer decoder (along with a segmentation head) takes the transformer encoder's output and object queries as inputs. It decodes the object queries to produce a binary mask and the corresponding class label.

The operations in the transformer decoder and segmentation head are referred to together as h(·). Thus, the output of the meta-architecture with K encoder layers (a predicted mask \tilde{y}_{K}⁽ⁱ⁾ and corresponding label [symbol] ) can be written as:

$$\{ {\tilde{y}}_{K}^{( i )} , {\tilde{ℓ}}_{K}^{( i )} \} = h \cdot {f}_{K} \cdot … \cdot {f}_{2} \cdot {f}_{1} \cdot b ( {x}^{( i )} )$$

Here, the operation ∘ denotes function composition, e.g., g∘f(x)=g(f(x)), and subscript denotes output predicted using K encoder layers. With {y⁽ⁱ⁾, [symbol] } as the pair of ground truth segmentation map and corresponding image label x⁽ⁱ⁾, the final loss may be computed as

$${ℒ}_{K} = {λ}_{m a s k} {ℒ}_{mask} ( {\tilde{y}}_{K}^{( i )} , {y}^{( i )} ) + {λ}_{c l a s s} {ℒ}_{class} ( {\tilde{ℓ}}_{K}^{( i )} , {ℓ}^{( i )} )$$

where [symbol] (·,·) is a binary mask loss and [symbol] (·,·) is the corresponding classification loss. λₘₐₛₖ and λ_{class} represent the associated loss weights.

Layers within the transformer encoder exhibit non-uniform contributions to Panoptic Quality (PQ). Thus not all K=6 layers per image are needed, and layer usage may be minimized to fit computational constraints while preserving performance. An early exiting approach may therefore take advantage of three components: Model suitability, efficient and effective gating, and dynamic control for managing the cost-performance tradeoff.

A model may therefore be used that not only permits early exits, improves accuracy as the network deepens. Exiting early in such a framework does not compromise the overall performance of the model. The efficacy of an early exiting strategy further relies on the ability to make informed exit decisions. A gating network therefore balances reducing computational overhead with accurately identifying skippable components. Additionally, computational cost and performance are balanced based on user priorities. This allows the model to exit at the optimal layer based on specific needs and desired outcomes, ensuring efficient resource allocation and maximizing utility in various application scenarios, particularly in resource-constrained environments like edge computing or real-time applications.

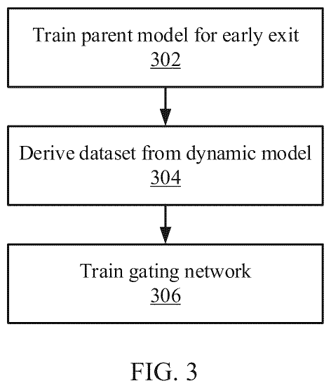

Referring now to FIG. 3, a method for training a panoptic segmentation model is shown. Block 302 trains a parent model for early exit via the transformer encoder. Block 304 then derives a dataset from the trained model. These two steps together may be interpreted as model preprocessing. Block 306 then trains the gating network to learn optimal exit points in the encoder, tailored to user's requirements, which provides model adaptation.

The training of block 302 enables the model to exit at the encoder. To maintain consistently high performance at each exit point, the output of each stochastic depth is passed to a shared transformer decoder and the loss [symbol] is determined for each exit point k. Direct training in this fashion does not encourage the model to use fewer layers to extract and prioritize informative representations. To address this, a set of coefficients αₖ are used to emphasize the quality of representations at later layers, enabling earlier layers to also focus on producing effective intermediate representations. As the layer depth increases, the corresponding coefficient αₖ grows, ensuring a progressively stricter standard for feature quality. The new loss function is then expressed as:

$${ℒ}_{total} = \frac{1}{N} {\sum }_{i}^{N} {\sum }_{k}^{K} {α}_{k} {ℒ}_{k} , where ∀ k < {k}^{′} , {α}_{k} < {α}_{{k}^{′}}$$

where N is the number of images in the training set.

To enable informed exit decisions during inference, the gating network is trained to learn optimal exit strategies using an intermediate dataset. The performance of a pretrained stochastic depth model, from block 302, is measured at all potential exit points for each image in the training dataset at block 304 to create a derived dataset [symbol] . Specifically, each image x⁽ⁱ⁾ is associated with a vector q⁽ⁱ⁾ of length K, where each element qₖ⁽ⁱ⁾ represents the predicted panoptic quality upon exiting at the encoder layer k. Hence, each sample in [symbol] can be represented as (x⁽ⁱ⁾, q⁽ⁱ⁾)∈ [symbol] .

In block 306, the gating network is trained on [symbol] to self-select a number of encoder layers for an input image. Exiting should ideally be allowed at the encoder layer which results in the highest quality segmentation map. Rather than simply exiting at the layer producing the highest segmentation quality, the gating network finds the best balance between segmentation quality and computational efficiency.

Block 306 first establishes the target exit for the gating network. Although panoptic quality generally increases with increasing encoder layers, the gating network prioritizes increasing the panoptic quality while also reducing the number of layers. Thus a utility function combines the segmentation quality and the depth of the network:

$$u ( k ) = {q}_{k}^{( i )} - β k$$

where β serves as an adaptation factor governing the tradeoff between segmentation quality and computational cost. A higher value of β signifies a greater emphasis on efficiency over segmentation quality.

A target exit point t⁽ⁱ⁾ is determined for each image x⁽ⁱ⁾ using:

$${t}^{( i )} = {arg max}_{k} u ( k )$$

With a target designated for each image, the gating decision is expressed as a classification problem. The gating architecture may include a pooling operation z(·) on the token length dimension followed by a linear layer with weights W, producing output logits as:

$${g}^{( i )} = Wz ( {s}_{1}^{( i )} )$$

The output of the lowest resolution feature map s₁ is used as input to the pooling operation so that the gating network has a minimal impact on the computational efficiency of the model. A cross-entropy loss may be used between the output logits g⁽ⁱ⁾ and the one-hot version of the target exit t⁽ⁱ⁾ as the training objective for the gating network. During inference, the gating network identifies the layer with the highest predicted logits

$$( e . g . , {arg max}_{k} ( {g}_{k}^{( i )} ) )$$

as the optimal exit layer for the image x⁽ⁱ⁾.

The present model can adapt to varying computational constraints. In scenarios where a smaller model is needed, only the gating network needs to be retrained by repeating block 306. Assuming the computational load is proportional to the depth of the network, the performance gain can be weighed against the computational overhead for each exit layer. The total number of layers K or the value of β may thus be adjusted to fit user preferences. For example, a smaller K may be used to enforce a smaller model.

During inference, the gating network guides the parent model to an optimal exit point tailored to each input image. The gating network processes low-resolution features from the backbone and generates a vector of length K for each image. The gating network identifies the layer with the highest predicted logits as the optimal exit layer for each image. The parent model implements this by exiting as the determined layer and subsequently proceeds to a final prediction. This dynamic model ensures that the model adaptively selects the optimal layer for exit during inference, enhancing its efficiency in handling diverse input data.

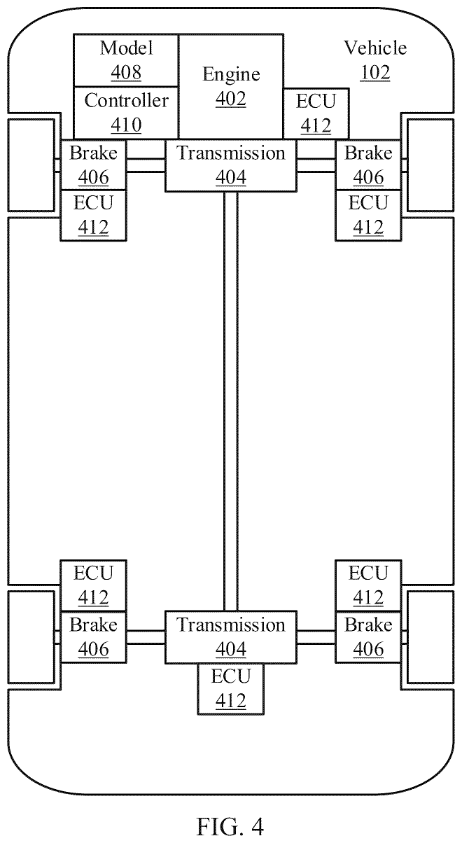

Referring now to FIG. 4, additional detail on a vehicle 102 is shown. A number of different sub-systems of the vehicle 102 are shown, including an engine 402, a transmission 404, and brakes 406. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 412, which perform measurements of the state of the respective sub-system. For example, ECUs 412 relating to the brakes 406 may control an amount of pressure that is applied by the brakes 406. An ECU 412 associated with the wheels may further control the direction of the wheels. The information that is gathered by the ECUs 412 is supplied to the controller 410.

Communications between ECUs 412 and the sub-systems of the vehicle 102 may be conveyed by any appropriate wired or wireless communications medium and protocol. For example, a car area network (CAN) may be used for communication. The time series information may be communicated from the ECUs 412 to the controller 410, and instructions from the controller 410 may be communicated to the respective sub-systems of the vehicle 102.

The controller 410 uses the output of the panoptic segmentation model 408, based on information collected from cameras, to identify objects and hazards within the scene. The model 408 may, for example, output a labeled image of a road scene that is labeled according to faults that have been detected.

The controller 410 may communicate internally, to the sub-systems of the vehicle 102 and the ECUs 412. Based on detected road fault information, the controller 410 may communicate instructions to the ECUs 412 to avoid a hazardous road condition. For example, the controller 410 may automatically trigger the brakes 406 to slow down the vehicle 102 and may furthermore provide steering information to the wheels to cause the vehicle 102 to move around a hazard.

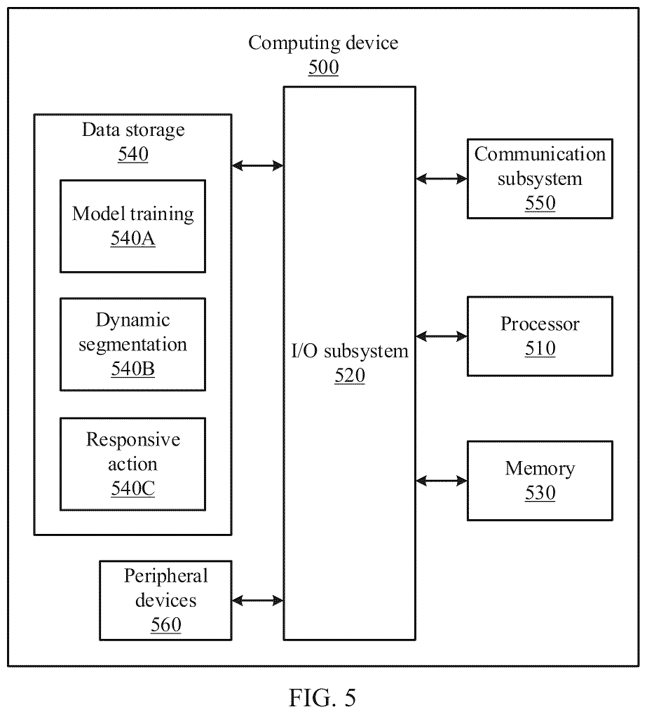

Referring now to FIG. 5, an exemplary computing device 500 is shown, in accordance with an embodiment of the present invention. The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for training a model, 540B for performing dynamic segmentation, and/or 540C for performing an automatic action a detected road fault. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

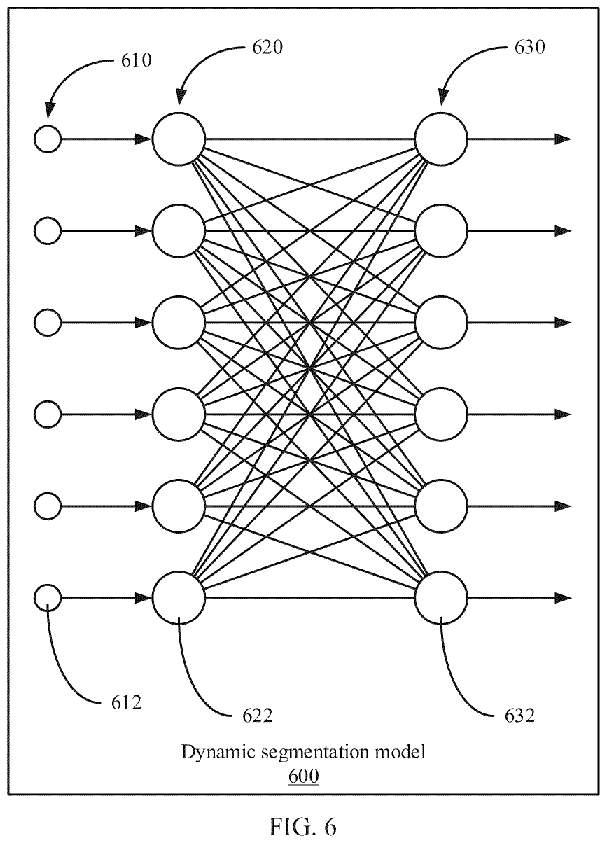

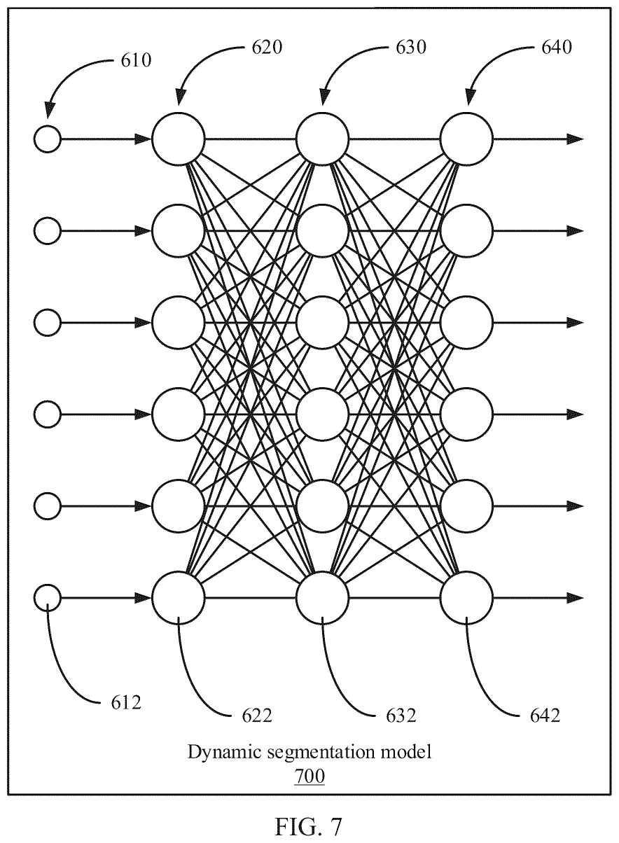

Referring now to FIGS. 6 and 7, exemplary neural network architectures are shown, which may be used to implement parts of the present models, such as the dynamic segmentation model 600/700. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for segmentation, comprising:
encoding an image using a backbone model to generate a plurality of feature maps;
selecting an exit point based on one of the plurality of feature maps;
processing the feature maps with a dynamic transformer encoder that includes a plurality of layers, exiting the dynamic transformer encoder at a layer identified by the exit point; and
decoding an output of the dynamic transformer encoder to output a segmentation of the image.

2. The method of claim 1, wherein the exit point is selected based on a lowest-resolution feature map of the plurality of feature maps.

3. The method of claim 1, wherein selecting the exit point is performed using a gating network that includes a pooling layer and a linear layer to select a target layer of the plurality of layers.

4. The method of claim 3, further comprising retraining the gating network to reflect a change in computational efficiency needs.

5. The method of claim 1, wherein the backbone model is a visual transformer encoder and the decoding is performed by a visual transformer decoder.

6. The method of claim 1, wherein selecting the exit point weighs segmentation quality against computational efficiency to maximize efficiency without sacrificing quality.

7. The method of claim 1, wherein the plurality of feature maps include feature maps of different resolutions and wherein decoding the output includes generating respective segmentations for each of the plurality of feature maps.

8. The method of claim 1, wherein the segmentation of the image includes identification of objects within the image.

9. The method of claim 1, further comprising controlling an autonomous vehicle responsive to the segmentation to avoid an obstacle or hazard in a scene shown by the image.

10. The method of claim 9, wherein controlling the autonomous vehicle includes performing a steering, accelerating, or decelerating action.

11. A system for segmentation, comprising:
a hardware processor;
a memory that stores a computer program which, when executed by the hardware processor, causes the hardware processor to:
encode an image using a backbone model to generate a plurality of feature maps;
select an exit point based on one of the plurality of feature maps;
process the feature maps with a dynamic transformer encoder that includes a plurality of layers, exiting the dynamic transformer encoder at a layer identified by the exit point; and
decode an output of the dynamic transformer encoder to output a segmentation of the image.

12. The system of claim 11, wherein the exit point is selected based on a lowest-resolution feature map of the plurality of feature maps.

13. The system of claim 11, wherein the exit point is selected using a gating network that includes a pooling layer and a linear layer to select a target layer of the plurality of layers.

14. The system of claim 13, wherein the computer program further causes the hardware processor to retrain the gating network to reflect a change in computational efficiency needs.

15. The system of claim 11, wherein the backbone model is a visual transformer encoder and the decoding is performed by a visual transformer decoder.

16. The system of claim 11, wherein the exit point selection weighs segmentation quality against computational efficiency to maximize efficiency without sacrificing quality.

17. The system of claim 11, wherein the plurality of feature maps include feature maps of different resolutions and wherein the computer program further causes the hardware processor to generate respective segmentations for each of the plurality of feature maps.

18. The system of claim 11, wherein the segmentation of the image includes identification of objects within the image.

19. The system of claim 11, wherein the computer program further causes the hardware processor to perform a steering, accelerating, or decelerating action on an autonomous vehicle responsive to the segmentation to avoid an obstacle or hazard in a scene shown by the image.

20. An autonomous vehicle, comprising:
a camera that captures an image of a scene;
a hardware processor; and
a memory that stores a computer program which, when executed by the hardware processor, causes the hardware processor to:
encode an image using a backbone model to generate a plurality of feature maps;
select an exit point based on one of the plurality of feature maps;
process the feature maps with a dynamic transformer encoder that includes a plurality of layers, exiting the dynamic transformer encoder at a layer identified by the exit point;
decode an output of the dynamic transformer encoder to output a segmentation of the image; and
perform a steering, accelerating, or decelerating action responsive to the segmentation to avoid an obstacle or hazard in the scene shown by the image.
